(19) United States
(12) Patent Application Publication
(10) Pub. No.: US 2021/0059278 A1
(43) Pub. Date: Mar. 4, 2021

(54) PROCESS FOR PREPARING TRANSPARENT EMULSIONS

(71) Applicant: PEPSICO, INC., Purchase, NY (US)

(72) Inventors: Badreddine AHTCHI-ALI, Wildwood Crest, NJ (US); Slavka Stoyanova TCHOLAKOVA, Sofia (BG); Nikolai Denkov DENKOV, Sofia (BG); Sonya Rusiyanova TSIBRANSKA-GYOREVA, Sofia (BG); Dilek Fahretin GAZOLU-RUSANOVA, Sliven (BG)

(73) Assignee: PEPSICO, INC., Purchase, NY (US)

(21) Appl. No.: 16/559,920

(22) Filed: Sep. 4, 2019

(51) Int. Cl. A23L 2/44; B01F 17/00; A23L 2/46; A23L 2/56; A23L 33/115; A23L 29/00

(52) U.S. Cl. CPC A23L 2/44; B01F 17/0028; A23L 29/035; A23L 2/56; A23L 33/115; A23L 2/46

(57) ABSTRACT

This disclosure provides a process for preparing transparent emulsions, in particular emulsions that are free of solvents such as propylene glycol, for use in producing clear beverages.

### FIELD

The present disclosure relates to processes for preparing transparent emulsions, and in particular, emulsions that are free of solvents such as propylene glycol, that are useful for preparing clear beverages.

### BACKGROUND

Emulsions containing flavor oils are frequently used to prepare soft drinks. Where a clear beverage is desired, it is critical that the emulsion shows no signs of creaming or ring formation upon preparation and during storage. Typically, transparency is achieved through the use of high levels of emulsifiers and solvents such as propylene glycol. However, regulations limiting the concentration of propylene glycol in beverage formulations have reduced the utility of this solution. As such, alternative methods for preparing stable, solvent-free transparent emulsions are needed.

### BRIEF SUMMARY

In a first aspect, the present disclosure provides a process for preparing a transparent emulsion, the process comprising mixing about 5 to about 15 wt % of one or more oils with an aqueous composition comprising:

(a) about 0.5 to about 20 wt % of one or more preservatives,

(b) optionally about 0.01 to about 50 wt % of one or more acids, and

(c) about 5 to about 25 wt % of an emulsifier.

In a first embodiment of the first aspect, the emulsifier is a polysorbate. In a second embodiment of the first aspect, the emulsifier is polysorbate 60 or polysorbate 80.

In a third embodiment of the first aspect, the one or more preservatives are selected from the group consisting of sodium citrate, sodium benzoate, and potassium sorbate.

In a fourth embodiment of the first aspect, the one or more acids are selected from the group consisting of citric acid and malic acid. In a fifth embodiment of the first aspect, the one or more acids is citric acid.

In a sixth embodiment of the first aspect, the one or more oils comprises one or more flavor oils. In a seventh embodiment of the first aspect, the one or more flavor oils is lemon oil or a combination of lemon oil and orange oil.

In an eighth embodiment of the first aspect, the emulsion has a pH from about 6.5 to about 8.5. In a ninth embodiment of the first aspect, the emulsion has a pH from about 1 to about 3.

In a tenth embodiment of the first aspect, the aqueous composition is prepared by adding the one or more preservatives and, optionally, the one or more acids, to a solution of the emulsifier in water. In an eleventh embodiment of the first aspect, the aqueous composition is heated to a temperature of about 60° C.

In a twelfth embodiment of the first aspect, the mixing is conducted at a temperature of from about 60° C. to about 90° C. In a thirteenth embodiment of the first aspect, the mixing is conducted with a high-speed disperser.

In a fourteenth embodiment of the first aspect, the mixing is conducted at a temperature of from about 60 to about 90° C. then cooled to a temperature of about 0° C. to about 25° C.

In a fifteenth embodiment of the first aspect, the mixing is conducted at room temperature. In a sixteenth embodiment of the first aspect, the mixing is conducted with a high pressure homogenizer.

In a seventeenth embodiment of the first aspect, the mixing is conducted at a temperature of about 0° C. to about 25° C. In an eighteenth embodiment of the first aspect, the mixing is conducted with a sonicator.

In a nineteenth embodiment of the first aspect, the transparent emulsion is stable for up to 3 months. In a twentieth embodiment of the first aspect, the transparent emulsion is stable for more than 3 months.

In a second aspect, the present disclosure provides an emulsion comprising:

about 0.5 to about 20 wt % of one or more preservatives;

optionally about 0.05 to about 40 wt % of one or more acids;

5 to about 25 wt % of an emulsifier; and

about 5 to about 15 wt % of one or more oils,

wherein the emulsion has a turbidity of less than about 10 NTUs.

### BRIEF DESCRIPTION OF THE DRAWINGS/FIGURES

FIG. 1 shows the scores for transparency of the emulsions.

### DETAILED DESCRIPTION

### Definitions

The singular forms “a,” “an,” and “the” include plural referents unless the context clearly dictates otherwise.

As used herein, the term “or” is a logical disjunction (i.e., and/or) and does not indicate an exclusive disjunction unless expressly indicated as such with the terms “either,” “unless,” “alternatively,” and words of similar effect.

As used herein, the term “about” refers to ±10% of the noted value, unless otherwise specified, and unless the upper bound of the range would exceed 100% of the composition, in which case the upper limit of the range is limited to 99.9%. Thus, and by way of example only, a composition including about 10 weight percent of a given ingredient could have from 9 to 11 weight percent of the compound. Similarly, a composition including about 95 weight percent of a given ingredient could have from 85.5 to 99.9 weight percent of the ingredient in the composition.

As used herein, the term “acid” refers to a suitable food grade acid. Suitable food grade acids are water soluble acids, including, but not limited to, phosphoric acid, sorbic acid, ascorbic acid, benzoic acid, citric acid, tartaric acid, propionic acid, butyric acid, acetic acid, succinic acid, glutaric acid, maleic acid, malic acid, valeric acid, caproic acid, ascorbic acid, malonic acid, aconitic acid, amino acids, and combinations thereof. Such acids are suitable for adjusting the pH of the food or beverage.

As used herein, the term “emulsifier” refers to an agent that allows an aqueous phase and an oil phase to be blended into an emulsion. Examples of emulsifiers include, but are not limited to, gums such as gum acacia, modified starch, carboxymethylcellulose, gum tragacanth, gum ghatti and combinations thereof; and polysorbates such as polysorbate 20, polysorbate 40, polysorbate 60, polysorbate 80, and combinations thereof. Additional examples of emulsifying agents will be apparent to those skilled in the art of food or beverage formulations, given the benefit of this disclosure.

As used herein, the term “flavor oil” means any oil that imparts flavor to a food or beverage. Examples of flavor oils include, but are not limited to, berry oil (such as strawberry oil), cocoa oil, cinnamon oil, nutmeg oil, coriander oil, neroli oil, lemon oil, lime oil, orange oil, grapefruit oil, vanilla oil, apple oil, kiwi oil, banana oil, and combinations thereof.

As used herein, the term “preservative” refers to all suitable preservatives approved for use in food or beverage compositions. Examples of preservatives include, but are not limited to, benzoates, such as sodium, calcium, and potassium benzoate; sorbates, such as sodium, calcium, and potassium sorbate; citrates, such as sodium citrate and potassium citrate.

As used herein, the term “transparent” refers to optical clarity. The extent of clarity or cloudiness of a composition can be determined quantitatively at 20±2° C. using a turbidimeter, for example a HACH Turbidimeter (Model 2100AN, Hach Company, Loveland, Colo.). Turbidimeters provide a measurement of turbidity in Nephelometric Turbidity Units (NTUs). The instrument can be calibrated using a STABLCAL Calibration Kit including samples having turbidities ranging from 0.1 NTU to 7500 NTU. Test samples can be measured in a Turbidimeter glass vial and NTU values can be read after a 30 second stabilization period. A transparent emulsion or beverage is an emulsion or beverage having a turbidity less than about 5 NTU.

All percentages provided in this specification are percentages by weight, unless specifically indicated otherwise.

### Compositions

The present disclosure provides transparent emulsions which are useful for preparing clear beverages. In certain embodiments, the emulsions of the present disclosure are free of solvents such as propylene glycol. The emulsions of the present disclosure comprise one or more oils and an aqueous composition. In some embodiments, the one or more oils comprise one or more flavor oils. In some embodiments, the one or more flavor oils are selected from the group consisting of strawberry oil, apple oil, kiwi oil, banana oil, neroli oil, lemon oil, lime oil, orange oil, and grapefruit oil, and combinations thereof. In some embodiments, the one or more flavor oils are selected from the group consisting of neroli oil, lemon oil, lime oil, grapefruit oil, orange oil, and combinations thereof. In some embodiments, the one or more oils are selected from the group consisting of lemon oil and orange oil. In certain embodiments, the one or more oils is lemon oil. In some embodiments, the one or more oils is a combination of lemon oil and orange oil.

In certain embodiments, the emulsion comprises from about 5% to about 15% of one or more oils. In some embodiments, the emulsion comprises from about 5% to about 14% of one or more oils. In some embodiments, the emulsion comprises from about 5% to about 13% of one or more oils. In some embodiments, the emulsion comprises from about 5% to about 12% of one or more oils. In some embodiments, the emulsion comprises from about 5% to about 11% of one or more oils. In some embodiments, the emulsion comprises from about 5% to about 10% of one or more oils. In some embodiments, the emulsion comprises about 5%, about 6%, about 7%, about 8%, about 9%, about 10%, about 11%, about 12%, about 13%, about 14%, or about 15% of one or more oils. In certain embodiments, the emulsion comprises from about 5% to about 10% lemon oil. In some embodiments, the emulsion comprises about 10% lemon oil.

In certain embodiments, the emulsion comprises a combination of orange oil and lemon oil. In some embodiments, the ratio (weight:weight) of orange oil to lemon oil is from about 1:99 to about 99:1. In some embodiments, the ratio of orange oil to lemon oil is about 85:15 to about 15:85. In some embodiments, the ratio of orange oil to lemon oil is about 75:25 to about 25:75. In some embodiments, the ratio of orange oil to lemon oil is about 65:45 to about 45:65. In some embodiments, the ratio of orange oil to lemon oil is about 50:50. In some embodiments, the emulsion comprises about 10% of about a 1:1 mixture of orange oil and lemon oil.

The emulsions described herein comprise an aqueous composition, i.e. a composition comprising water and one or more additives, such as, but not limited to, one or more preservatives, one or more acids, and one or more emulsifiers. In certain embodiments, the aqueous composition comprises one or more preservatives. In some embodiments, the one or more preservatives are selected from the group consisting of sodium benzoate, calcium benzoate, potassium benzoate, sodium sorbate, calcium sorbate, potassium sorbate, sodium citrate, potassium citrate, and combinations thereof. In some embodiments, the one or more preservatives are selected from the group consisting of sodium benzoate, potassium sorbate, sodium citrate, and combinations thereof. In particular embodiments, the preservative is sodium benzoate, potassium sorbate, sodium citrate, or combinations thereof.

In certain embodiments, the aqueous composition comprises from about 0.5% to about 20% of one or more preservatives. In some embodiments, the aqueous composition comprises from about 0.5% to about 15% of one or more preservatives. In some embodiments, the aqueous composition comprises from about 0.5% to about 14% of one or more preservatives. In some embodiments, the aqueous composition comprises from about 0.5% to about 13% of one or more preservatives. In some embodiments, the aqueous composition comprises from about 0.5% to about 12% of one or more preservatives. In some embodiments, the aqueous composition comprises from about 0.5% to about 11% of one or more preservatives. In some embodiments, the aqueous composition comprises from about 0.5% to about 10% of one or more preservatives. In certain embodiments, the aqueous composition comprises from about 0.5% to about 9% of one or more preservatives. In certain embodiments, the aqueous composition comprises from about 0.5% to about 8% of one or more preservatives. In certain embodiments, the aqueous composition comprises from about 0.5% to about 7% of one or more preservatives. In certain embodiments, the aqueous composition comprises from about 0.5% to about 6% of one or more preservatives. In certain embodiments, the aqueous composition comprises from about 0.5% to about 5% of one or more preservatives.

In some embodiments, the aqueous composition comprises from about 5% to about 15% of one or more preservatives. In some embodiments, the aqueous composition comprises from about 6% to about 15% of one or more preservatives. In some embodiments, the aqueous composition comprises from about 7% to about 15% of one or more preservatives. In some embodiments, the aqueous composition comprises from about 8% to about 15% of one or more preservatives. In some embodiments, the aqueous composition comprises from about 9% to about 15% of one or more preservatives. In some embodiments, the aqueous composition comprises from about 9% to about 14% of one or more preservatives. In some embodiments, the aqueous composition comprises from about 9% to about 13% of one or more preservatives. In some embodiments, the aqueous composition comprises from about 9% to about 12% of one or more preservatives.

In some embodiments, the aqueous composition comprises about 0.5%, about 1%, about 1.5%, about 2%, about 2.5%, about 3%, about 3.5%, about 4%, about 4.5% about 5%, about 5.5%, about 6%, about 6.5%, about 7%, about 7.5%, about 8%, about 8.5%, about 9%, about 9.5% about 10%, about 10.5%, about 11%, about 11.5%, about 12%, about 12.5%, about 13%, about 13.5%, about 14%, about 14.5%, or about 15% of one or more preservatives.

In certain embodiments, the aqueous composition comprises from about 0.5% to about 10% sodium citrate. In some embodiments, the aqueous composition comprises from about 0.5% to about 9% sodium citrate. In some embodiments, the aqueous composition comprises from about 0.5% to about 8% sodium citrate. In some embodiments, the aqueous composition comprises from about 0.5% to about 7% sodium citrate. In some embodiments, the aqueous composition comprises from about 0.5% to about 6% sodium citrate. In some embodiments, the aqueous composition comprises from about 0.5% to about 5% sodium citrate. In some embodiments, the aqueous composition comprises from about 1% to about 5% sodium citrate. In some embodiments, the aqueous composition comprises from about 2% to about 5% sodium citrate. In some embodiments, the aqueous composition comprises from about 3% to about 5% sodium citrate. In some embodiments, the aqueous composition comprises about 0.5%, about 1%, about 1.5%, about 2%, about 2.5%, about 3%, about 3.5%, about 4%, about 4.5% about 5%, about 5.5%, about 6%, about 6.5%, about 7%, about 7.5%, about 8%, about 8.5%, about 9%, about 9.5% about 10% sodium citrate.

In certain embodiments, the aqueous composition comprises from about 0.5% to about 15% sodium benzoate. In some embodiments, the aqueous composition comprises from about 0.5% to about 14% sodium benzoate. In some embodiments, the aqueous composition comprises from about 0.5% to about 14% sodium benzoate. In some embodiments, the aqueous composition comprises from about 0.5% to about 13% sodium benzoate. In some embodiments, the aqueous composition comprises from about 0.5% to about 12% sodium benzoate. In some embodiments, the aqueous composition comprises from about 0.5% to about 11% sodium benzoate. In some embodiments, the aqueous composition comprises from about 0.5% to about 10% sodium benzoate. In some embodiments, the aqueous composition comprises about 0.5%, about 1%, about 1.5%, about 2%, about 2.5%, about 3%, about 3.5%, about 4%, about 4.5% about 5%, about 5.5%, about 6%, about 6.5%, about 7%, about 7.5%, about 8%, about 8.5%, about 9%, about 9.5% about 10%, about 10/5%, about 11%, about 11.5%, about 12%, about 12.5%, about 13%, about 13.5%, about 14%, about 14.5%, or about 15% sodium benzoate.

In certain embodiments, the aqueous composition comprises from about 0.5% to about 15% potassium sorbate. In some embodiments, the aqueous composition comprises from about 0.5% to about 14% potassium sorbate. In some embodiments, the aqueous composition comprises from about 0.5% to about 14% potassium sorbate. In some embodiments, the aqueous composition comprises from about 0.5% to about 13% potassium sorbate. In some embodiments, the aqueous composition comprises from about 0.5% to about 12% potassium sorbate. In some embodiments, the aqueous composition comprises from about 0.5% to about 11% potassium sorbate. In some embodiments, the aqueous composition comprises from about 0.5% to about 10% potassium sorbate. In some embodiments, the aqueous composition comprises about 0.5%, about 1%, about 1.5%, about 2%, about 2.5%, about 3%, about 3.5%, about 4%, about 4.5% about 5%, about 5.5%, about 6%, about 6.5%, about 7%, about 7.5%, about 8%, about 8.5%, about 9%, about 9.5% about 10%, about 10/5%, about 11%, about 11.5%, about 12%, about 12.5%, about 13%, about 13.5%, about 14%, about 14.5%, or about 15% potassium sorbate.

In certain embodiments, the aqueous composition comprises from about 5% to about 15% of a combination of sodium benzoate and potassium sorbate. In some embodiments, the aqueous composition comprises from about 6% to about 14% of a combination of sodium benzoate and potassium sorbate. In some embodiments, the aqueous composition comprises from about 7% to about 13% of a combination of sodium benzoate and potassium sorbate. In some embodiments, the aqueous composition comprises from about 8% to about 12% of a combination of sodium benzoate and potassium sorbate. In some embodiments, the aqueous composition comprises from about 9% to about 11% of a combination of sodium benzoate and potassium sorbate. In some embodiments, the aqueous composition comprises about 5%, about 5.5%, about 6%, about 6.5%, about 7%, about 7.5%, about 8%, about 8.5%, about 9%, about 9.5% about 10%, about 10.5%, about 11%, about 11.5%, about 12%, about 12.5%, about 13%, about 13.5%, about 14%, about 14.5%, or about 15% of a combination of sodium benzoate and potassium sorbate. In certain embodiments, the ratio (weight:weight) of sodium benzoate to potassium sorbate is from about 9:1 to about 1:9. In some embodiments, the ratio of sodium benzoate to potassium sorbate is from about 8:1 to about 1:8. In some embodiments, the ratio of sodium benzoate to potassium sorbate is from about 7:1 to about 1:7. In some embodiments, the ratio of sodium benzoate to potassium sorbate is from about 6:1 to about 1:6. In some embodiments, the ratio of sodium benzoate to potassium sorbate is from about 5:1 to about 1:5. In some embodiments, the ratio of sodium benzoate to potassium sorbate is from about 4:1 to about 1:4. In some embodiments, the ratio of sodium benzoate to potassium sorbate is from about 3:1 to about 1:3. In some embodiments, the ratio of sodium benzoate to potassium sorbate is from about 2:1 to about 1:2. In some embodiments, the ratio of sodium benzoate to potassium sorbate is about 1:1.

In certain embodiments, the aqueous composition comprises from about 5% to about 15% of a 1:1 (weight:weight) ratio of sodium benzoate:potassium sorbate. In some embodiments, the aqueous composition comprises from about 8% to about 12% of a 1:1 ratio of sodium benzoate:potassium sorbate. In some embodiments, the aqueous composition comprises from about 9% to about 11% of a 1:1 ratio of sodium benzoate:potassium sorbate. In some embodiments, the aqueous composition comprises about 5%, about 5.5%, about 6%, about 6.5%, about 7%, about 7.5%, about 8%, about 8.5%, about 9%, about 9.5% about 10%, about 10.5%, about 11%, about 11.5%, about 12%, about 12.5%, about 13%, about 13.5%, about 14%, about 14.5%, or about 15% of a 1:1 ratio of sodium benzoate:potassium sorbate.

The aqueous compositions described herein optionally comprise one or more acids. In certain embodiments acid is completely or substantially absent from the aqueous composition. As used herein, “substantially absent” means that the aqueous composition comprises less than about 0.1%, or less than about 0.05%, or less than about 0.01% of acid. In other embodiments, the aqueous composition comprises one or more acids. In some embodiments, the one or more acids are selected from the group consisting of sorbic acid, benzoic acid, citric acid, tartaric acid, propionic acid, butyric acid, acetic acid, succinic acid, glutaric acid, maleic acid, malic acid, valeric acid, caproic acid, malonic acid, aconitic acid, and combinations thereof. In some embodiments, the one or more acids are selected from the group consisting of citric acid, acetic acid, malic acid, and combinations thereof. In some embodiments, the one or more acids are citric acid, malic acid, or a combination thereof.

In certain embodiments, the aqueous composition comprises about 0.01% to about 60% of one or more acids. In some embodiments, the aqueous composition comprises about 0.01% to about 20% of one or more acids. In some embodiments, the aqueous composition comprises about 0.05% to about 15% of one or more acids. In some embodiments, the aqueous composition comprises about 0.05% to about 10% of one or more acids. In some embodiments, the aqueous composition comprises about 0.05% to about 5% of one or more acids. In some embodiments, the aqueous composition comprises about 0.05% to about 1% of one or more acids. In some embodiments, the aqueous composition comprises about 0.05% to about 0.5% of one or more acids. In some embodiments, the aqueous composition comprises about 0.05% to about 0.1% of one or more acids. In some embodiments, the aqueous composition comprises about 0.05%, about 0.06%, about 0.07%, about 0.08%, about 0.09%, or about 0.1% of one or more acids.

In some embodiments, the aqueous composition comprises about 10% to about 60% of one or more acids. In some embodiments, the aqueous composition comprises about 15% to about 50% of one or more acids. In some embodiments, the aqueous composition comprises about 20% to about 40% of one or more acids. In some embodiments, the aqueous composition comprises about 25% to about 40% of one or more acids. In some embodiments, the aqueous composition comprises about 25%, about 26%, about 27%, about 28%, about 29%, about 30%, about 31%, about 32%, about 33%, about 34%, about 35%, about 36%, about 37%, about 38%, about 39%, or about 40% of one or more acids.

In certain embodiments, the aqueous composition comprises from about 0.01% to about 60% citric acid. In some embodiments, the aqueous composition comprises from about 0.05% to about 10% citric acid. In some embodiments, the aqueous composition comprises from about 0.05% to about 5% citric acid. In some embodiments, the aqueous composition comprises about 0.05% to about 1% citric acid. In some embodiments, the aqueous composition comprises about 0.05% to about 0.5% citric acid. In some embodiments, the aqueous composition comprises about 0.05% to about 0.1% citric acid. In some embodiments, the aqueous composition comprises about 0.05%, about 0.06%, about 0.07%, about 0.08%, about 0.09%, or about 0.1% citric acid. In some embodiments, the aqueous composition comprises from about 10% to about 40% citric acid. In some embodiments, the aqueous composition comprises about 15% to about 40% citric acid. In some embodiments, the aqueous composition comprises about 20% to about 40% citric acid. In some embodiments, the aqueous composition comprises about 25% to about 40% citric acid. In some embodiments, the aqueous composition comprises about 25%, about 26%, about 27%, about 28%, about 29%, about 30%, about 31%, about 32%, about 33%, about 34%, about 35%, about 36%, about 37%, about 38%, about 39%, or about 40% citric acid.

In certain embodiments, the aqueous composition comprises from about 0.01% to about 60% malic acid. In some embodiments, the aqueous composition comprises from about 0.05% to about 30% malic acid. In some embodiments, the aqueous composition comprises from about 0.05% to about 20% malic acid. In some embodiments, the aqueous composition comprises from about 0.05% to about 1% malic acid. In some embodiments, the aqueous composition comprises about 0.05% to about 0.5% malic acid. In some embodiments, the aqueous composition comprises about 0.05%, about 0.06%, about 0.07%, about 0.08%, about 0.09%, about 0.10%, about 0.11%, about 0.12%, about 0.13%, about 0.14%. about 0.15%, about 0.16%, about 0.17%, about 0.18%, about 0.19% or about 0.2% malic acid. In some embodiments, the aqueous composition comprises from about 10% to about 40% malic acid. In some embodiments, the aqueous composition comprises from about 10% to about 30% malic acid. In some embodiments, the aqueous composition comprises from about 10% to about 25% malic acid. In some embodiments, the aqueous composition comprises about 10%, about 11%, about 12%, about 13%, about 14%, about 15%, about 16%, about 17%, about 18%, about 19%, about 20%, about 21%, about 22%, about 23%, about 24%, or about 25% malic acid.

In certain embodiments, the aqueous composition comprises from about 20% to about 40% of one or more acids and from about 0.5% to about 5% of one or more preservatives. In some embodiments, the aqueous composition comprises from about 20% to about 40% citric acid and about 0.5% to about 5% of a preservative selected from the group consisting of sodium benzoate and sodium citrate. In some embodiments, the aqueous composition comprises from about 25% to about 40% citric acid and from about 0.5% to about 1.25% sodium benzoate. In some embodiments, the aqueous composition comprises from about 25% to about 40% citric acid and from about 3% to about 5% sodium citrate.

In certain embodiments, the aqueous composition comprises from about 0.05% to about 1% of one or more acids and from about 8% to about 12% of one or more preservatives. In some embodiments, the aqueous composition comprises from about 0.05% to about 1% citric acid and from about 8% to about 12% of a preservative selected from the group consisting of sodium benzoate, potassium sorbate, and a combination thereof. In some embodiments, the aqueous composition comprises from about 0.05% to about 0.25% citric acid and from about 8% to about 12% sodium benzoate. In some embodiments, the aqueous composition comprises from about 0.05% to about 0.25% citric acid and from about 8% to about 12% potassium sorbate. In some embodiments, the aqueous composition comprises from about 0.05% to about 0.25% citric acid and from about 8% to about 12% of a combination of sodium benzoate and potassium sorbate.

Typically, the emulsions described herein comprise an emulsifier. In certain embodiments, the emulsifier is a polysorbate. In some embodiments, the emulsifier is selected from the group consisting of polysorbate 20, polysorbate 40, polysorbate 60, polysorbate 80, and combinations thereof. In some embodiments, the emulsifier is selected from the group consisting of polysorbate 60, polysorbate 80, and combinations thereof. In some embodiments, the emulsifier is polysorbate 60. In some embodiments, the emulsifier is polysorbate 80.

In certain embodiments the aqueous composition comprises about 5% to about 25% of an emulsifier. In some embodiments, the aqueous composition comprises about 10% to about 25% of an emulsifier. In some embodiments, the aqueous composition comprises about 15% to about 25% of an emulsifier. In some embodiments, the aqueous composition comprises about 15% to about 24% of an emulsifier. In some embodiments, the aqueous composition comprises about 15% to about 23% of an emulsifier. In some embodiments, the aqueous composition comprises about 15% to about 22% of an emulsifier. In some embodiments, the aqueous composition comprises about 15% to about 21% of an emulsifier. In some embodiments, the aqueous composition comprises about 15% to about 20% of an emulsifier. In some embodiments, the aqueous composition comprises about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, or about 25% of an emulsifier.

In certain embodiments, the aqueous composition comprises from about 5% to about 20% of an emulsifier, about 20% to about 40% of one or more acids, and from about 0.5% to about 5% of one or more preservatives. In some embodiments, the aqueous composition comprises from about 15% to about 20% of an emulsifier, about 20% to about 40% of one or more acids, and from about 0.5% to about 5% of one or more preservatives. In some embodiments, the aqueous composition comprises from about 15% to about 20% of an emulsifier selected from the group consisting of polysorbate 80 and polysorbate 60, from about 20% to about 40% citric acid and about 0.5% to about 5% of a preservative selected from the group consisting of sodium benzoate and sodium citrate. In some embodiments, the aqueous composition comprises from about 15% to about 20% polysorbate 80, from about 20% to about 40% citric acid, and from about 0.5% to about 1.25% sodium benzoate. In some embodiments, the aqueous composition comprises about 15% polysorbate 60, from about 20% to about 40% citric acid, and from about 0.5% to about 1.25% sodium benzoate. In some embodiments, the aqueous composition comprises from about 15% to about 20% of an emulsifier selected from the group consisting of polysorbate 80 and polysorbate 60, from about 20% to about 40% citric acid, and from about 3% to about 5% sodium citrate. In some embodiments, the aqueous composition comprises from about 15% to about 20% polysorbate 80, from about 25% to about 40% citric acid, and from about 3% to about 5% sodium citrate.

In certain embodiments, the aqueous composition comprises from about 15% to about 20% of an emulsifier selected from the group consisting of polysorbate 80 and polysorbate 60 and from about 15% to about 20% malic acid. In some embodiments, the aqueous composition comprises about 20% polysorbate 80 and about 20% malic acid. In some embodiments, the aqueous composition comprises about 15% polysorbate 60 and from about 15% to about 20% malic acid.

In certain embodiments, the aqueous composition comprises from about 5% to about 20% of an emulsifier, from about 0.05% to about 1% of one or more acids and from about 8% to about 12% of one or more preservatives. In some embodiments, the aqueous composition comprises from about 15% to about 20% of an emulsifier, from about 0.05% to about 1% of one or more acids and from about 8% to about 12% of one or more preservatives. In some embodiments, the aqueous composition comprises from about 15% to about 20% of an emulsifier selected from the group consisting of polysorbate 80 and polysorbate 60, from about 0.05% to about 1% of an acid selected from the group consisting of citric acid and malic acid, and from about 8% to about 12% of a preservative selected from the group consisting of sodium benzoate, potassium sorbate, and a combination thereof. In some embodiments, the aqueous composition comprises from about 15% to about 20% polysorbate 80, from about 0.05% to about 0.25% citric acid and from about 8% to about 12% sodium benzoate. In some embodiments, the aqueous composition comprises from about 15% to about 20% polysorbate 80, from about 0.05% to about 0.25% citric acid and from about 8% to about 12% potassium sorbate. In some embodiments, the aqueous composition comprises from about 15% to about 20% polysorbate 80, from about 0.05% to about 0.25% citric acid, and from about 8% to about 12% of a combination of sodium benzoate and potassium sorbate. In some embodiments, the aqueous composition comprises from about 15% to about 20% polysorbate 80, from about 0.05% to about 0.25% malic acid and from about 8% to about 12% sodium benzoate. In some embodiments, the aqueous composition comprises from about 15% to about 20% polysorbate 60, from about 0.05% to about 0.25% citric acid and from about 8% to about 12% sodium benzoate. In some embodiments, the aqueous composition comprises from about 15% to about 20% polysorbate 60, from about 0.05% to about 0.25% citric acid and from about 8% to about 12% potassium sorbate. In some embodiments, the aqueous composition comprises from about 15% to about 20% polysorbate 60, from about 0.05% to about 0.25% citric acid, and from about 8% to about 12% of a combination of sodium benzoate and potassium sorbate. In some embodiments, the aqueous composition comprises from about 15% to about 20% polysorbate 60, from about 0.05% to about 0.25% malic acid and from about 8% to about 12% sodium benzoate.

In certain embodiments, the aqueous composition comprises from about 15% to about 20% of an emulsifier selected from the group consisting of polysorbate 80 and polysorbate 60 and from about 8% to about 12% of a preservative selected from the group consisting of sodium benzoate, potassium sorbate, and a combination thereof. In some embodiments, the aqueous composition comprises about 15% to about 20% polysorbate 80 and about 8% to about 12% sodium benzoate. In some embodiments, the aqueous composition comprises about 15% to about 20% polysorbate 80 and about 8% to about 12% potassium sorbate. In some embodiments, the aqueous composition comprises about 15% to about 20% polysorbate 60 and about 8% to about 12% sodium benzoate. In some embodiments, the aqueous composition comprises about 15% to about 20% polysorbate 60 and about 8% to about 12% potassium sorbate. In some embodiments, the aqueous composition comprises about 15% to about 20% polysorbate 80 and about 8% to about 12% of a combination of sodium benzoate and potassium sorbate. In some embodiments, the aqueous composition comprises about 15% to about 20% polysorbate 60 and about 8% to about 12% of a combination of sodium benzoate and potassium sorbate.

The emulsions described herein are typically stable when stored at room temperature. As used herein, “stable” means that an emulsion's turbidity does not exceed more than about 10 NTUs when measured according to the procedures described herein, even after prolonged storage, such as about 3 months or more than about 3 months, for example, about four, about five, about six months, or more than six months. Alternatively, a stable emulsion may experience a turbidity decrease and/or the emulsion's turbidity may remain the same over prolonged storage such as about 3 months or more than about 3 months, for example, about four, about five, about six months, or more than six months. In certain embodiments, the emulsion's transparency can increase upon storage at room temperature for a period of about three months. In some embodiments, the emulsion's transparency does not change upon storage at about 18° C. to about 27° C. for a period of about three months. In some embodiments, the emulsion's transparency decreases upon storage at about 18 to about 27° C. However, in these instances the emulsions do not cream or form precipitates and provide clear beverages upon dilution. In certain embodiments, the emulsions are stable at about 18° C. to about 27° C. for at least about one month. In some embodiments, the emulsions are stable at about 18° C. to about 27° C. for at least about three months. In some embodiments, the emulsions are stable at about 18° C. to about 27° C. for at least about six months. In some embodiments, the emulsions are stable at about 18° C. to about 27° C. for at least about twelve months.

### Processes

The transparent emulsions described herein can be prepared according to several methods. In certain embodiments, one or more stabilizers and optionally one or more acids can be added to an aqueous solution of an emulsifier in water. In some embodiments, the resulting mixture can be stirred and optionally heated to 60° C. if necessary to ensure the additives and emulsifier are dissolved, providing the aqueous composition. In certain embodiments, one or more oils can be added to the aqueous composition and the resulting mixture of oil and aqueous composition (a “pre-emulsion”) can be stirred. In some embodiments, the pre-emulsion can be stirred for about 15 minutes to about 60 minutes. In some embodiments, the pre-emulsion can be heated to a temperature of about 60° C. and about 100° C. while stirring. In some embodiments, the pre-emulsion can be heated to a temperature of about 80° C. to about 100° C. while stirring. In some embodiments, the pre-emulsions can be heated to a temperature of about 90° C. to about 100° C. while stirring. In some embodiments, the pre-emulsion can be heated to a temperature of about 70° C. to about 90° C. Without being bound by a particular theory, it is believed that pre-emulsions having a higher concentration of emulsifier and acid produce transparent emulsions with heating to about 70° C., while those with a lower concentration of emulsifier and/or acid produce transparent emulsions at temperatures of about 80° C. to about 90° C. Following this mixing and heating process, the pre-emulsion is emulsified. Once the pre-emulsion has been heated and stirred, it is typically cooled to provide a transparent emulsion. In some embodiments, the emulsion can be cooled in an ice and water bath at a temperature of about 0° C. to about 10° C. In some embodiments, the emulsion can be cooled in a cold water bath at a temperature of about 10° C. to about 20° C. In some embodiments, the emulsion can be cooled by thermostat at a rate of about 0.33° C./min to a temperature of about 0° C. It should be understood that cooling can also be conducted by other methods known to those of ordinary skill in the art.

Alternative methods for stirring can be used to prepare the emulsions of the present disclosure. In certain embodiments, the emulsions can be prepared by stirring the pre-emulsion with a high-speed disperser. Examples of high-speed dispersers include the Ultra Turrax® dispersers, Ross® high-speed dispersers, and Hockmeyer® high-speed dispersers. One of ordinary skill in the art would be familiar with high-speed dispersers and where to purchase them. In some embodiments, the pre-emulsion can be heated while being stirred on a high-speed disperser. In some embodiments, the pre-emulsion can be heated to a temperature of at least 50° C. In some embodiments the pre-emulsion can be heated to a temperature of about 60° C. to about 90° C. In some embodiments, the pre-emulsion can be heated to a temperature of between about 60° to about 80° C. In some embodiments, the rotor speed of the disperser can be from about 13000 rpm to about 25000 rpm. In some embodiments, the rotor speed of the disperser can be from about 13000 rpm to about 20500 rpm. In some embodiments, the rotor speed of the disperser can be from about 13000 rpm to about 14000 rpm. In some embodiments, the rotor speed of the disperser can be about 13500 rpm. In some embodiments, the pre-emulsion can be stirred for about 1 minute to about 10 minutes. In some embodiments, the pre-emulsion can be stirred for about 2 minutes to about 9 minutes. In some embodiments, the pre-emulsion can be stirred for about 3 minutes to about 8 minutes. In some embodiments, the pre-emulsion can be stirred for about 3 minute to about 7 minutes. In some embodiments, the pre-emulsion can be stirred for about 4 minute to about 6 minutes. In some embodiments, the pre-emulsion can be stirred for about 5 minutes.

In certain embodiments, the emulsions can be prepared by sonicating the pre-emulsions. Sonication is known to those of skill in the art. However, typically, an SKL 1500-IIDN sonicator (Ningbo Haishu Sklon Development Co., Ltd, China) can be used. In certain embodiments, the pre-emulsion can be cooled to a temperature of about 0° C. to about 10° C. and sonicated with a pulse sonicator. In some embodiments, the pulses are from about 0.5 seconds to about 2 seconds in length. In some embodiments, the pulses are from about 0.5 seconds to 1.5 seconds in length. In some embodiments, the pulses are about 1 second in length. In some embodiments, time in between pulses is from about 0.25 to about 1 second. In some embodiments, the time in between pulses is from about 0.25 to about 0.75 seconds. In some embodiments, the time in between pulses is about 0.5 seconds.

Sonication strength can be varied throughout the process by adjusting the power level of the sonicator. In certain embodiments, the sonicator's power level can be set to about 100 watts to about 200 watts. In some embodiments, the sonicator's power level can be set to about 250 watts to about 350 watts. In some embodiments, the sonicator's power level can be set to about 1100 watts to about 1300 watts. In some embodiments, the sonicator's power level can be set to about 150 watts, then increased to about 300 watts, then increased to about 1200 watts. In some embodiments, the pre-emulsion can be sonicated for about 1 minute to about 24 hours. In some embodiments, the pre-emulsion can be sonicated for about 1 minute to about 1 hour. In some embodiments, the pre-emulsion can be sonicated for about 1 minute to about 30 minutes. In some embodiments, the pre-emulsion can be sonicated for about 1 minute to about 10 minutes. In some embodiments, the pre-emulsion can be sonicated for about 2 minutes to about 9 minutes. In some embodiments, the pre-emulsion can be sonicated for about 3 minutes to about 8 minutes. In some embodiments, the pre-emulsion can be sonicated for about 3 minutes to about 7 minutes. In some embodiments, the pre-emulsion can be sonicated for about 4 to about 6 minutes.

In some embodiments, high-pressure homogenization can be used to prepare the emulsions of the present disclosure. High pressure homogenization is known to those of ordinary skill in the art. However, typically, a PandaPLUS 2000 (GEA Niro Soavi) high pressure homogenizer can be used. In certain embodiments, the pressure on the high-pressure homogenizer can be set to about 100 bar to about 2200 bar. In some embodiments, the pressure on the high-pressure homogenizer can be set to about 200 bar to about 2000 bar. In some embodiments, the pressure on the high-pressure homogenizer can be set to about 400 bar to about 1700 bar. In some embodiments, the pressure can be set to about 900 bar to about 1100 bar. In some embodiments, the pressure can be set to about 250, 500, 750, or 1000 bar. In certain embodiments, the pre-emulsions can be passed through the high pressure homogenizer from about 1 time to about 10 times. In some embodiments, the pre-emulsions can be passed through the homogenizer about 2 times to about 9 times. In some embodiments, the pre-emulsions can be passed through the homogenizer about 3 times to about 8 times. In some embodiments, the pre-emulsions can be passed through the homogenizer about 1, 2, 3, 4, 5, 6, 7, 8, 9, or 10 times. In some embodiments, the pre-emulsions can be passed through the homogenizer more than 10 times.

### EXAMPLES

### Emulsifiers

All solutions were prepared with deionized water obtained from an Elix 5 water purification system (Millipore, USA).

TABLE 1
Reagents

| | Abbreviation | |
|---|---|---|
| Type | Used in Text | Trade Name |
| Low molecular; | T60 | Tween 60 |
| synthetic | T80 | Tween 80 |
| Sugars | Sucrose | Sucrose |
| Preservatives | Na-benz | Sodium benzoate |
| | K-sorb | Potassium sorbate |
| | Na-Citr | Sodium citrate |
| Acids | CAc | Citric acid |
| | MAc | Malic acid |
| Oil | | Lemon Oil (C&A |
| | | LTD item no. |
| | | 17I97LOC) |
| | | Orange Oil (C&A |
| | | LTD item no. |
| | | 171660TP) |

### Methods

### Example 1: General Procedure for Emulsification Using Heat Treatment

An aqueous phase was prepared by dissolving an emulsifier in water and adding appropriate additives such as acid and/or preservatives. The resulting mixture was stirred using a magnetic stirrer with optional heating to 60° C. if necessary for dissolution of the additives and emulsifier. Oil (typically flavor oil) was added and the resulting pre-emulsion was transferred to a water bath, heated to 90° C., and stirred for 15 min at 900 rpm. Immediately after heat treatment, the emulsions were cooled in a cold water bath (˜18-20° C.) with constant gentle shaking. The resulting emulsions were analyzed with respect to drop size, turbidity and stability.

### Example 2: General Procedure for Emulsification with High-Speed Dispersion

An aqueous phase was prepared by dissolving an emulsifier in water and adding appropriate additives such as acid and/or preservatives. The resulting mixture was stirred on a magnetic stirrer with optional heating to 60° C. if necessary for dissolution of the additives and emulsifier. Oil (typically flavor oil) was added and the resulting pre-emulsion was transferred to a water bath heated to 50° C., 60° C., 70° C., or 80° C. The pre-emulsions were stirred on an Ultra Turrax, UT high-speed disperser (Janke & Kunkel GmbH & Co, IKA-Labortechnik) for 5 minutes at 13500 rpm then immediately cooled in a cold water bath (˜18-20° C.) with constant gentle shaking. The resulting emulsions were analyzed with respect to drop size, turbidity and stability.

### Example 3: General Procedure for Emulsification with Sonication

An aqueous phase was prepared by dissolving an emulsifier in water and adding appropriate additives such as acid and/or preservatives. The resulting mixture was stirred on a magnetic stirrer with optional heating to 60° C. if necessary for dissolution of the additives and emulsifier. Oil (typically flavor oil) was added and the resulting pre-emulsion was transferred to an ice water bath. The sonicator (SKL 1500-IIDN, Ningbo Haishu Sklon Development Co., Ltd, China), was set to 1 second long pulses with 0.5 seconds off and a sonotrode with a diameter of 20 mm was attached to the device. The pre-emulsion was sonicated according to the following steps:
1. 10% power (150 W) output was applied for 30 seconds with constant shaking to incorporate the oil inside the solution;
2. 20% power (300 W) output was then applied for 1 minute with gentle shaking to further homogenize the sample;
3. 80% power (1200 W) output was applied for 4 minutes with gentle shaking.

### Example 4: General Procedure for Emulsification by High-Pressure Homogenization

An aqueous phase was prepared by dissolving an emulsifier in water and adding appropriate additives such as acid and/or preservatives. The resulting mixture was stirred on a magnetic stirrer with optional heating to 60° C. if necessary for dissolution of the additives and emulsifier. Oil (typically flavor oil) was added and the resulting pre-emulsion was mixed by hand with a spoon. The pressure of the homogenizer (PandaPLUS 2000, GEA Niro Soavi) was fixed to 250 bar, 500 bar, 750 bar, or 1000 bar and the pre-emulsion was passed several times (indicated for each experiment) through the homogenizer. The resulting emulsions were analyzed with respect to drop size, turbidity and stability.

### Example 5: General Procedure for Scoring Transparency of Concentrated Emulsions

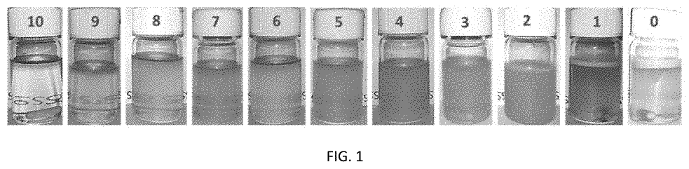

To quantify the degree of transparency of the concentrated emulsions, a score with a value between 0 and 10 was attributed to each emulsion, as shown in FIG. 1. The transparency of the emulsions gradually decreased as the scores went down from 10 to 4. Scores of 0 to 3 indicated the presence of a ring of creaming droplets. The size of the ring significantly increased as the scores decreased from 3 to 0.

### General Procedure for Preparation of Diluted (Beverage) Emulsions

After 1 month of storage, the emulsions were diluted in plastic (PET) bottles of 0.5 L according to the following procedure:

1. A pre-syrup was prepared by mixing sucrose, ascorbic acid and hot water. The quantities for each component are specified in Table 2. After that, the solution was stirred with a magnetic stirrer until the solids were fully dissolved. For the beverage emulsions without sucrose, a solution of 0.0131 wt % ascorbic acid was prepared.

2. Solutions of 7.5 wt % citric acid and 0.75 wt % sodium benzoate were also prepared. Depending on the composition of the concentrated emulsion, certain amounts were taken from these solutions and mixed with the pre-syrup inside the bottle.

3. 0.547 g of concentrated emulsion was added to the pre-syrup and the bottle was filled by adding water to a total weight of 500 g. The concentrations of the different ingredients after dilution are provided in Table 3.

4. The diluted emulsions were carefully homogenized and the bottles were stored at room temperature (20-25° C.) standing upright. The samples were observed for any change in transparency and pictures of the bottles were taken within the day of dilution.

TABLE 2
Sugar, Ascorbic Acid, and Water Used for Pre-Syrup Preparation

| | Mass (g) for | wt % | wt % |
|---|---|---|---|
| | 500 mL | Concentration | Concentration |
| Component | Bottles | in Pre-Syrup | in Bottles |
| Sucrose | 55.41 | 55.72 | 11.08 |
| Ascorbic Acid | 0.013 | 0.0131 | 0.0026 |
| Total Amount of | 99.45 | — | — |
| Pre-Syrup in | | | |
| Bottle | | | |

TABLE 3
Final Concentrations of Ingredients in Bottles

| | 15% Tween | | 20% Tween | |
|---|---|---|---|---|
| | Mass (g) | wt % | Mass (g) | wt % |
| | for 500 mL | Concentration | for 500 mL | Concentration |
| Component | Bottles | in Bottles | Bottles | in Bottles |
| Oil | 0.0547 | 0.0109 | 0.0547 | 0.0109 |
| Tween | 0.074 | 0.0148 | 0.0985 | 0.0197 |
| Sucrose | 55.41 | 11.08 | 55.41 | 11.08 |
| *Acids (Citric, Malic) | 0.74 | 0.1482 | 0.74 | 0.1482 |
| Preservatives (Sodium | 0.077 | 0.0153 | 0.077 | 0.0153 |
| Benzoate, Potassium | | | | |
| Sorbate, or Mixture of | | | | |
| Both) | | | | |
| Ascorbic Acid | 0.013 | 0.0026 | 0.013 | 0.0026 |
| Water (From Emulsion, | 443.63 | 88.726 | 443.61 | 88.722 |
| Pre-Syrup, and Added to | | | | |
| Fill Bottle) | | | | |

*The acidity and the level of preservatives in the diluted emulsions were fixed by using the concentrated solution of citric acid and sodium benzoate mentioned in Step 2. For example, if the concentrated emulsion contained malic acid and potassium sorbate, the amounts of added solutions of 7.5% citric acid and 0.75% sodium benzoate were recalculated in a way that gave the total amount of acids (malic and citric acid) and preservatives (potassium sorbate and sodium benzoate) indicated in Table 3. The pH of all prepared diluted emulsions was 2.5.

### Results

Representative results from the study performed using magnetic stirring with heat treatment have been summarized in Table 4 below. The scores (assigned as described in Example 5) that were obtained after 1 and 3 months of storage have been provided and any significant change that occurred in the visual appearance has been indicated. Any change in score over 1 was counted as a noteworthy change in the visual appearance of the sample and was not considered to be within the margin of error of score formation. Each of the emulsions shown in Tables 4 and 5 was diluted into a mock beverage after one month of storage using the procedure described herein. Emulsions with a “*” were cloudy when initially prepared, but clarified over several days to one week. All other emulsions produced clear beverages.

TABLE 4
Representative Emulsions Prepared Using Heat Treatment

| | | | Score | | |
|---|---|---|---|---|---|
| | | | After 1 | After 3 | Changes in Visual |
| System | | | Month | Months | appearance |
| Low pH | 15% T80 | 40% CAc + 1% Na-benz* | 7 | 6.5 | No |
| | | 40% CAc + 4.72% Na-citr | 9.5 | 0 | Precipitates |
| | | 35.8% CAc + 4.2% Na-citr | 9 | 9 | No |
| | | 26.8% CAc + 3.2% Na-citr | 9 | 8.5 | No |
| | | 20% MAc | 8.5 | 1 | Ring formation |
| | 20% T80 | 40% CAc + 0.5% Na-benz | 9.5 | 9 | No |
| | | 40% CAc + 4% Na-benz | 10 | 0 | Oil separation |
| | | 40% CAc + 4.72% Na-citr | 9 | 0 | Precipitates |
| | | 20% MAc | 6.5 | 5 | Increased turbidity |
| | 15% T60 | 40% CAc + 1% Na-benz* | 9 | 6.5 | Increased turbidity |
| | | 40% CAc + 4.72% Na-citr | 9.5 | 9.5 | No |
| | | 35.8% CAc + 4.2% Na-citr | 9.5 | 9 | No |
| | | 26.8% CAc + 3.2% Na-citr | 9.5 | 9.5 | No |
| | | 15% MAc | 8 | 4 | Increased turbidity |
| | | 20% MAc | 8.8 | 4 | Increased turbidity |
| | 20% T60 | 35.8% CAc + 4.2% Na-citr | 9 | 0 | Precipitates |
| | | 20% MAc | 6.5 | 0 | Ring formation, gelation |
| | | 10% 1:1 lemon oil:orange oil + | 9.5 | 4 | Increased turbidity |
| | | 40% (CAc + Na-citr) | | | |
| | 15% T80 | 10% Na-benz + 0.05% CAc* | 5 | 6 | No |
| | | 10% Na-benz + 0.1% CAc* | 7.5 | 8 | No |
| | | 10% K-sorb | 8 | 7.5 | No |
| | | 10% K-sorb + 0.05% CAc | 8 | 7 | No |
| | | 10% K-sorb + 0.1% CAc | 7.5 | 7 | No |
| | 20% T80 | 10% Na-benz | 8 | 8.5 | No |
| | | 10% Na-benz + 0.05% CAc | 9 | 9 | No |
| | | 10% Na-benz + 0.1% CAc | 10 | 10 | No |
| | | 10% K-sorb | 9 | 8 | No |
| | | 10% K-sorb + 0.05% CAc | 9 | 8 | No |
| | | 10% K-sorb + 0.1% CAc | 8.5 | 6.5 | Increased turbidity |
| | | 10% Na-benz* | 9 | 9 | No |
| | 15%T60 | 10% Na-benz + 0.05% CAc* | 9 | 9 | No |
| | | 10% Na-benz + 0.1% CAc* | 8.5 | 9 | No |
| | | 10% K-sorb | 8 | 9 | No |
| | | 10% K-sorb + 0.05% CAc | 9.5 | 9 | No |
| | | 10% K-sorb + 0.1% CAc | 9.5 | 9 | No |
| | | 10% Na-benz + 0.1% MAc | 9 | 8.5 | No |
| | 20% T60 | 10% Na-benz* | 10 | 9.5 | No |
| | | 10% Na-benz + 0.05% CAc* | 10 | 9.5 | No |
| | | 10% Na-benz + 0.1% CAc | 9.5 | 9.5 | No |
| | | 9% Na-benz + 0.1% CAc | 7 | 6 | No |
| | | 9% Na-benz + 0.09% CAc | 10 | 10 | No |
| | | 10% K-sorb | 9.5 | 9 | No |
| | | 10% K-sorb + 0.05% CAc | 9 | 9 | No |
| | | 10% K-sorb + 0.1% CAc | 9 | 9 | No |
| | | 10% Na-benz + 0.1% MAc | 4 | 6.5 | Increased transparency |
| | | 5% Na-benz + 5% K-sorb | 10 | 10 | No |
| | | 5% Na-benz + 5% K-sorb + | 9.5 | 9.5 | No |
| | | 0.05% CAc | | | |
| | | 5% Na-benz + 5% K-sorb + | 9.5 | 9.5 | No |
| | | 0.1% CAc | | | |
| | | 4.5% Na-benz + 4.5% K-sorb + | 9 | 9.5 | No |
| | | 0.09% CAc | | | |

TABLE 5
Representative Emulsions Prepared Using Other Processes

| | | | Score | | |
|---|---|---|---|---|---|
| | | | After One | After One | Change in Visual |
| Process | System | Temperature | Week | Month | Appearance |
| High-Speed | 20% T60 + 10% Na-benz* | 60 | 10 | 4 | Increased turbidity, |
| Dispersion | | | | | no ring formation |
| High-Speed | 20% T60 + 10% Na-benz* | 70 | 10 | 5 | Increased turbidity, |
| Dispersion | | | | | no ring formation |
| High-Speed | 20% T60 + 10% Na-benz* | 80 | 9.5 | 4 | Increased turbidity, |
| Dispersion | | | | | no ring formation |
| High-Speed | 20% T60 + 35.78% CAc + | 60 | 6.5 | 4 | Increased turbidity, |
| Dispersion | 4.22% Na-citr | | | | no ring formation |
| High-Speed | 20% T60 + 35.78% CAc + | 70 | 7 | 5 | Increased turbidity, |
| Dispersion | 4.22% Na-citr+ | | | | no ring formation |
| High-Speed | 20% T60 + 35.78% CAc + | 80 | 9.5 | 3.5 | Increased turbidity, |
| Dispersion | 4.22% Na-citr | | | | no ring formation |
| Sonication | 20% T60 + 5% Na-benz* | 0 | 7.5 | 4.5 | Increased turbidity |
| Sonication | 20% T60 + 7% Na-benz* | 0 | 7.5 | 5.5 | Increased turbidity |
| Sonication | 20% T60 + 9% Na-benz* | 0 | 7.5 | 5 | Increased turbidity |
| Sonication | 20% T60 + 10% Na-benz* | 0 | 9 | 6 | Increased turbidity |
| Sonication | 20% T60 + 40% (CAc + | 0 | 10 | 8.5 | Increased turbidity |
| | Na-citr, pH ~2) | | | | |
| Sonication | 20% T60 + 10% Na-benz, | 0 | 9 | 9 | No |
| | 0.1% CAc | | | | |
| Sonication | 20% T60 + 5% Na-benz + | 0 | 9 | 9 | No |
| | 5% K-sorb | | | | |
| High-Pressure | 20% T60 + 10% Na-benz | room temperature | 3 | 3 | No |
| Homogenization | (1000 bar, 3 passes) | | | | |
| High-Pressure | 20% T60 + 40% (CAc + | room temperature | 10 | 10 | No |
| Homogenization | Na-citr, pH ~2) | | | | |
| | (1000 bar, 8 passes) | | | | |
| High-Pressure | 20% T60 + 10% Na-benz | room temperature | 10 | 10 | No |
| Homogenization | (750 bar, 10 passes) | | | | |
| High-Pressure | 20% T60 + 40% (CAc + | room temperature | 10 | 10 | No |
| Homogenization | Na-citr, pH ~2) | | | | |
| | (750 bar, 10 passes) | | | | |
| High-Pressure | 20% T60 + 10% Na-benz | room temperature | 10 | 10 | No |
| Homogenization | (500 bar, 10 passes) | | | | |
| High-Pressure | 20% T60 + 40% (CAc + | room temperature | 10 | 10 | No |
| Homogenization | Na-citr, pH ~2) | | | | |
| | (500 bar, 10 passes) | | | | |
| High-Pressure | 20% T60 + 10% Na-benz | room temperature | 9 | 10 | Increased transparency |
| Homogenization | (250 bar, 10 passes) | | | | |
| High-Pressure | 20% T60 + 40% (CAc + | room temperature | 10 | 10 | No |
| Homogenization | Na-citr, pH ~2) | | | | |
| | (250 bar, 10 passes) | | | | |

These results show that stable, transparent, solvent-free emulsions comprising an emulsifier, one or more preservatives and optionally one or more acids can be prepared using several different methodologies.

The breadth and scope of the present disclosure should not be limited by any of the above-described exemplary embodiments, but should be defined only in accordance with the following claims and their equivalents.

All patents, patent applications, and other reference noted or referenced in this application are hereby incorporated by reference in their entirety

What is claimed is:

1. A process for preparing a transparent emulsion, the process comprising mixing about 5 to about 15 wt % of one or more oils with an aqueous composition comprising:
(a) about 0.5 to about 20 wt % of one or more preservatives,
(b) optionally about 0.01 to about 50 wt % of one or more acids, and
(c) about 5 to about 25 wt % of an emulsifier.

2. The process of claim 1, wherein the emulsifier is a polysorbate.

3. The process of claim 2, wherein the emulsifier is polysorbate 60 or polysorbate 80.

4. The process of claim 1, wherein the one or more preservatives are selected from the group consisting of sodium citrate, sodium benzoate, and potassium sorbate.

5. The process of claim 1, wherein the one or more acids are selected from the group consisting of citric acid and malic acid.

6. The process of claim 5 wherein the one or more acids is citric acid.

7. The process of claim 1, wherein the one or more oils comprises one or more flavor oils.

8. The process of claim 7, wherein the one or more flavor oils is lemon oil or a combination of lemon oil and orange oil.

9. The process of claim 1, wherein the emulsion has a pH from about 6.5 to about 8.5.

10. The process of claim 1, wherein the emulsion has a pH from about 1 to about 3.

11. The process of claim 1, wherein the aqueous composition is prepared by adding the one or more preservatives and, optionally, the one or more acids, to a solution of the emulsifier in water.

12. The process of claim 11, wherein the aqueous composition is heated to a temperature of about 60° C.

13. The process of claim 1, wherein the mixing is conducted at a temperature of from about 60° C. to about 90° C.

14. The process of claim 13, wherein the mixing is conducted with a high-speed disperser.

15. The process of claim 13, wherein the mixing is conducted at a temperature of from about 60 to about 90° C. then cooled to a temperature of about 0° C. to about 25° C.

16. The process of claim 1, wherein the mixing is conducted at room temperature.

17. The process of claim 16, wherein the mixing is conducted with a high pressure homogenizer.

18. The process of claim 1, wherein the mixing is conducted at a temperature of about 0° C. to about 25° C.

19. The process of claim 18, wherein the mixing is conducted with a sonicator.

20. The process of claim 1 wherein the transparent emulsion is stable for up to 3 months.

21. The process of claim 1 wherein the transparent emulsion is stable for more than 3 months.

22. An emulsion comprising:
(a) about 0.5 to about 20 wt % of one or more preservatives;
(b) optionally about 0.05 to about 40 wt % of one or more acids;
(c) about 5 to about 25 wt % of an emulsifier; and
(d) about 5 to about 15 wt % of one or more oils,
wherein the emulsion has a turbidity of less than about 10 NTUs.
